(19) United States
(12) Patent Application Publication
(10) Pub. No.: US 2015/0108134 A1
(43) Pub. Date: Apr. 23, 2015

(54) APPARATUS THAT INCLUDES A SUCTION CUP MOUNT

(71) Applicant: Jiang FANGYUAN, Taizhou (CN)

(72) Inventor: Jiang FANGYUAN, Taizhou (CN)

(21) Appl. No.: 14/179,959

(22) Filed: Feb. 13, 2014

(30) Foreign Application Priority Data
Oct. 23, 2013 (CN) 201320653972.1

(51) Int. Cl. F16B 47/00; B65D 25/22; F16M 13/02

(52) U.S. Cl. CPC F16B 47/00; F16M 13/022; B65D 25/22
USPC 220/483; 248/205.8

(57) ABSTRACT

An apparatus that includes a suction cup mount having a suction cup, a cup cap, a drawing bar coupled to the suction cup at one end and having a distal end, and a press button coupled to the distal end of the drawing bar.

### FIELD OF INVENTION

The present invention relates to a mounting device and more particularly a mounting device that includes a releasable suction cup.

### BACKGROUND AND SUMMARY OF THE INVENTION

Suction cup mounts are known.

Patent No. 02206060.X discloses an example of a known suction cup mount that includes a suction cup, a cup cap, and a hanging hook. In this device, through the back hinge of the hook, a bar on the suction cup can be raised to create a vacuum between the suction cup and a surface to support the hook on the surface for hanging of heavy objects. Normally the suction cup is made of a soft plastic. It has been discovered that a suction cup made of soft plastic cannot provide strong support for a suction cup mount.

An apparatus according to the present invention includes a suction cup, a cup cap, a drawing bar molded into the suction cup, and a press button. According to an aspect of the present invention, the suction cup is made of a compliant material such as natural rubber. The drawing bar maybe made of a material that is more rigid than the material of the suction cup, for example, a relatively harder plastic.

A hole maybe provided at the free end of the drawing bar opposite the end that is connected to the suction cup. The cup cap may be provided with a slot or the like opening for receiving the drawing bar. The press button may be configured for engagement with the drawing bar. For example, the press button may include two opposing sidewalls to define a space for receiving the drawing bar. Each opposing sidewall of the press button may include a hole that registers with the hole at the free end of the drawing bar. A pivot pin or the like may then pass through the holes in the sidewalls of the press button and the free end of the drawing bar whereby the press button and the drawing bar become engaged with one another.

The press button may include embossed portions. When the press button is moved (e.g. rotated) the embossed portions push the cup cap in one direction while pulling the drawing bar in the opposite direction, thereby pulling the center of the suction cup. The operation of the apparatus results in the creation of a vacuum when the suction cup is in intimate contact with a flat surface (e.g. a wall) , whereby the device is attached to the surface.

In one embodiment, the apparatus may further include a hook integrated with the cup cap.

In another embodiment, the apparatus may include a bracket having a slot for receiving a flat body. At least one, but preferably two, apparatuses according to the second embodiment may be employed to provide a pair of mounts for an elongated, flat body to serve as a shelf.

In yet another embodiment, a vessel such as a cup or a container may be integrated with the press button.

Other features and advantages of the present invention will become apparent from the following description of the invention which refers to the accompanying drawings.

### BRIEF DESCRIPTION OF THE FIGURES

FIG. 1 depicts an apparatus according to a first embodiment of the present invention in a disassembled state.

FIG. 2 is a cross section of an apparatus according to the first embodiment in an inoperative state.

FIG. 3 is a cross section of an apparatus according to the first embodiment in an operative state.

FIG. 4 depicts an apparatus according to the second embodiment of the present invention supporting a shelf panel.

FIG. 5 depicts an apparatus according to a third embodiment of the present invention.

### DETAILED DESCRIPTION

A device according to the present invention is configured for daily uses such as hanging of an object on a surface.

An apparatus according to the present invention includes a novel suction cup that provide better coupling to a surface. The apparatus is simple and easy to use.

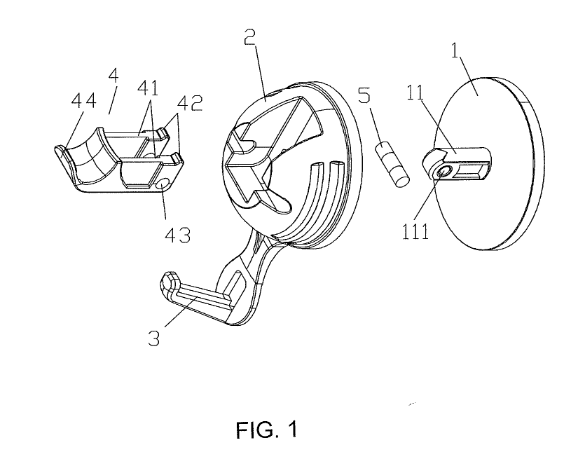

Referring to FIGS. 1-3, an apparatus according to the present invention includes a suction cup mount realized with a suction cup 1 that is preferably a circular body having a peripheral edge (preferably circular) surrounding a central region, a cup cap 2 having an uninterrupted and continuous rim (preferably circular) that abuts suction cup 1 interiorly of the peripheral edge of suction cup 1, a drawing bar 11 that is molded into the central region of suction cup 1 (preferably at the center of suction cup 1), and a press button 4.

Suction cup 1 is made of a compliant material such as rubber. Drawing bar is made of a rigid material and may include an enlarged end that is molded into suction cup 1. A preferred material for drawing bar 11 is a hard plastic.

Drawing bar 11 may include a hole 111 at a distal end thereof opposite the end (proximal) that is molded into the central region of suction cup 1.

Cup cap 2 may include a slot or some other opening through which drawing bar 4 is received.

Press button 4 is integrated with drawing bar 11. Preferably, press button 4 is rotatably coupled to the distal end of drawing bar 11.

In a preferred embodiment, press button 4 includes two oppositely arranged and spaced sidewalls 41. The distal end of drawing bar 11 is received in the space between sidewalls 41 of press button 4. Each sidewall 41 of press button 4 includes a hole 43, which registers with hole ill at the distal end of drawing bar 11. A pivot pin 5 may be inserted through holes 43 in sidewalls 41 and hole 111 at the distal end of drawing bar 11 to rotatably couple press button 4 to drawing bar 11.

Press button 4 may include two embossments 42 each projecting from a respective sidewall 41.

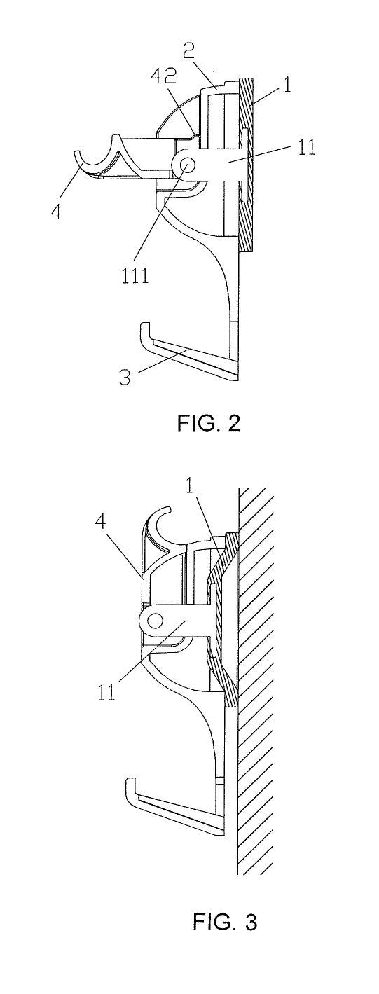

As shown in FIG. 2, when the apparatus is in an inoperative state, suction cup 1 can be placed in intimate contact with a flat surface (e.g. a wall). In this state embossments 42 are not in contact with cup cap 2, while other parts (e.g. bottom portions) of sidewalls 41 may be in contact with cup cap 2.

Referring to FIG. 3, when the apparatus is in an operative state, embossments 42 abut cup cap 2, drawing bar 11 is in a retracted state, suction cup 1 is deformed to create a vacuum between the wall and suction cup 1, and, press button 4 has been rotated from one orientation (e.g. generally aligned with drawing bar 11 along the same direction) to another orientation (e.g. generally transverse to the direction of elongation of drawing bar 11).

When suction cup 1 is arranged on a flat surface, such as a wall, in an inoperative state (FIG. 2) , press button 4 may be rotated about the longitudinal axis of pivot pin 5 to push cup cap 2 toward the wall while pulling drawing bar 11 away from the wall. Consequently, the rim of cup cap 2 presses against suction cup 1 interiorly of the peripheral edge of suction cup 1 trapping suction cup 1 between cup cap 2 and the wall to create a seal around the central region of suction cup 1 with the wall while at the same time drawing bar 11 pulls suction cup 1 toward the interior of cup cap 2 to create a vacuum between suction cup 1 and the wall, whereby the apparatus is suction mounted to the wall and becomes operative (FIG. 3).

According to an aspect of the present invention, suction cup 1 is made of natural rubber and may be 4.0-5.0 mm thick along its entire body except of course the region in which drawing bar 11 is received. It has been discovered that using a soft compliant suction cup (a suction cup made of natural rubber) that is sufficiently thick improves the coupling of the suction cup mount to a surface compared to suction cup mounts that use hard or soft plastic.

In a preferred configuration, press button 4 may include a hook 44 opposite holes 43 that can be grabbed by the user to cause the rotation of press button 4.

In the first embodiment, a hook 3 may be integrated with cup cap 2. In one preferred embodiment, cup cap 2 and hook 3 may be molded into a one piece unitary body.

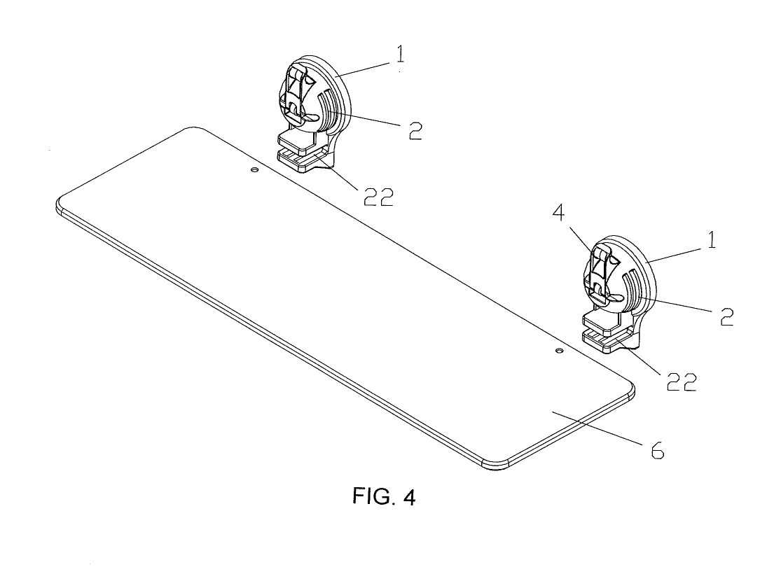

FIG. 4 depicts an apparatus according to the second embodiment of the present invention. An apparatus according to the second embodiment includes a bracket 22 integrated with cup cap 2 instead of a hook 3. Bracket 22 may include a slot or the like feature to receive a planar body such as a shelf 6. Two apparatuses according to the second embodiment of the present invention may be used to support a shelf as shown in FIG. 4.

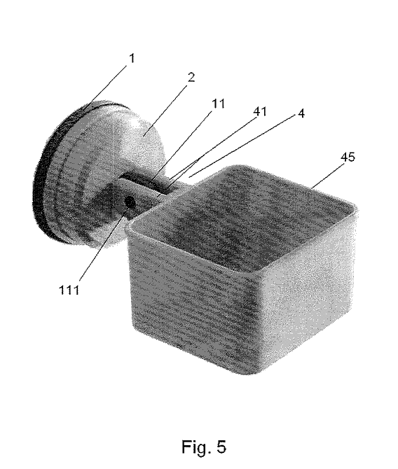

Referring to FIG. 5, an apparatus according to a third embodiment may include a vessel 45 that can be any type of container, such as a cup or a planter, integrated with press button 4. In this embodiment, press button 4 is configured to pull draw bar 11 away from the surface (e.g. a wall) on which suction cup 1 resides when sidewalls 41 of press button 4 are in a direction parallel to the direction of the axial alignment of draw bar 11. In this embodiment, when sidewalls 41 are oriented transverse to the direction axial alignment of draw bar 11, suction cup 1 is returned to its undeformed state and is released from the surface.

To operate the embodiment shown in FIG. 5, suction cup 11 is placed on a surface, and press button 4 is rotated about pivot pin 5 until sidewalls 41 are oriented parallel to the axial alignment of draw bar 11. During the rotation, press button 4 abuts cup cap 2, which forces cup cap 2 toward suction cup 1, while pulling draw bar 11 in the opposite direction, whereby suction cup 1 is suction-mounted as previously described.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An apparatus that includes a suction cup mount comprising:
a suction cup having a peripheral edge surrounding a central region,
a cup cap having a rim,
a drawing bar having one end integrated with the suction cup at a location in the central region of the suction cup and having a distal end opposite the one end which extends through the cup cap,
a press button coupled to the distal end of the drawing bar, wherein, when said suction cup is arranged on a flat surface, movement of the press button pushes the cup cap in one direction toward the surface while pulling the drawing bar in an opposite direction, whereby the suction cup is trapped between the surface and the rim of the cup cap while the central region of the suction cup is pulled away from the surface to create a vacuum.

2. An apparatus according to claim 1, wherein the suction cup is made of a compliant material and the drawing bar is made of a relatively rigid material.

3. An apparatus according to claim 2, wherein the suction cup is made of natural rubber and the drawing bar is made of a hard plastic.

4. A mount according to claim 1, wherein the suction cup is between 4.0-5.0 mm thick.

5. An apparatus according to claim 1, wherein the press button includes a hook.

6. An apparatus according to claim 1, further comprising a hook integrated with the cup cap.

7. An apparatus according to claim 6, wherein the hook and the cup cap are molded into a unitary body.

8. An apparatus according to claim 1, further comprising a bracket integrated with the cup cap.

9. An apparatus according to claim 8, wherein the bracket includes a slot configured for receiving a shelf panel.

10. An apparatus according to claim 9, wherein the bracket and the cup cap are molded into a unitary body.

11. An apparatus according to claim 1, wherein the press button and the drawing bar are rotatably coupled to one another.

12. An apparatus according to claim 11, wherein the press button includes two spaced sidewalls each with a respective embossment arranged to abut the cup cap when the press button is oriented to create the vacuum.

13. An apparatus according to claim 12, wherein the drawing bar is received between the sidewalls of the press button.

14. An apparatus according to claim 1, further comprising a vessel integrated with the press button.
